(19) United States
(12) Patent Application Publication
(10) Pub. No.: US 2023/0370332 A1
(43) Pub. Date: Nov. 16, 2023

(54) COMPUTER SYSTEM AND COMMUNICATION METHOD

(71) Applicant: RAKUTEN MOBILE, INC., Tokyo (JP)

(72) Inventor: Kazushige TAKEUCHI, Tokyo (JP)

(73) Assignee: RAKUTEN MOBILE, INC., Tokyo (JP)

(21) Appl. No.: 18/026,413

(22) PCT Filed: Jan. 22, 2021
(86) PCT No.: PCT/JP2021/002254

§ 371 Date: Mar. 15, 2023

(51) Int. Cl. H04L 41/0893; H04L 43/12; H04L 61/4511

(52) U.S. Cl. CPC H04L 41/0893; H04L 43/12; H04L 61/4511

(57) ABSTRACT

A GC cluster is a computer system in which a cluster of nodes on which a containerized application runs is constructed. The GC cluster communicates with a first CDC cluster that is another computer system in which the cluster is constructed and to which data on the containerized application is transmitted. The GC cluster communicates with a second CDC cluster that is still another computer system in which the cluster is constructed and to which the data is transmitted instead of the first CDC cluster. The GC cluster receives a bfd packet repeatedly transmitted from the first CDC cluster. The GC cluster transmits the data to the second CDC cluster instead of the first CDC cluster when the bfd packet transmitted from the first CDC cluster has not been received.

### TECHNICAL FIELD

The present disclosure relates to a data processing technology, and more particular, to a computer system and a communication method.

### BACKGROUND ART

Patent Literature 1 discloses that a DNS server is responsible for alive monitoring of and collection of load information on other servers, and when an active server falls into a high load state or a denial-of-service state, the DNS server issues a start command to a standby server and distributes, to the standby server, access from a newly connected client terminal.

### CITATION LIST

### Patent Literature

[Patent Literature 1] JP2019-168920 A

### SUMMARY OF INVENTION

### Technical Problem

As a recent trend, a cluster of nodes on which a containerized virtualized application (hereinafter, also referred to as a containerized application) runs is constructed at each site such as a data center. Hitherto, in order for nodes belonging to different clusters to perform communications with each other, it is necessary to access a global server load balancing (GSLB) device provided outside the clusters to resolve a name of a transmission destination cluster. When a failure occurs in a communication path between a transmission source cluster and the GSLB device, it takes time to retrieve a transmission destination address from the GSLB device, which may cause a delay in communications between the transmission source cluster and the transmission destination cluster.

The present disclosure has been made in view of such problems, and it is therefore an object of the present disclosure to provide a technology of reducing a delay in communications between computer systems, each having a cluster of nodes on which a containerized application runs constructed therein.

### Solution to Problem

In order to solve the above-described problems, one aspect of the present disclosure is a computer system in which a cluster of nodes on which a containerized application runs is constructed and that includes, in the nodes, a communication unit that communicates with a plurality of external systems. The communication unit communicates with a first external system that is another computer system in which the cluster is constructed and to which data on the containerized application is transmitted, and a second external system that is still another computer system in which the cluster is constructed and to which the data is transmitted instead of the first external system, and
the communication unit includes a receiver structured to receive a packet repeatedly transmitted from the first external system, the packet being used for monitoring whether a path between the computer system and the first external system is under a normal condition, and a transmitter structured to transmit the data to the second external system instead of the first external system when the packet has not been received from the first external system.

Another aspect of the present disclosure is a communication method. This method is a communication method performed by a computer system in which a cluster of nodes on which a containerized application runs is constructed, and the computer system includes, in the nodes, a communication unit that communicates with a plurality of external systems. The communication unit communicates with a first external system that is another computer system in which the cluster is constructed and to which data on the containerized application is transmitted, and a second external system that is still another computer system in which the cluster is constructed and to which the data is transmitted instead of the first external system, and the communication method includes causing the communication unit to receive a packet repeatedly transmitted from the first external system, the packet being used for monitoring whether a path between the computer system and the first external system is under a normal condition, and causing the communication unit to transmit the data to the second external system instead of the first external system when the packet has not been received from the first external system.

Note that any combination of the above-described components, or an entity that results from replacing expressions of the present disclosure among a device, a computer program, a recording medium recording a computer program in a readable manner, and the like is also valid as an aspect of the present disclosure.

### Advantageous Effects of Invention

According to the present disclosure, it is possible to reduce a delay in communications between computer systems, each having a cluster of nodes on which a containerized application runs constructed therein.

### BRIEF DESCRIPTION OF DRAWINGS

FIG. 1 is a diagram illustrating a configuration of a computer system in which a cluster of nodes on which a containerized application runs is constructed.

FIG. 2 is a diagram illustrating a configuration of a communication system of a first embodiment.

FIG. 3 is a diagram illustrating an example of a DNS record stored in a coredns of a GC cluster.

FIG. 4 is a flowchart illustrating how a GC cluster 12 acts.

FIG. 5 is a diagram illustrating an example of the DNS record stored in the coredns of the GC cluster.

FIG. 6 is a diagram illustrating a configuration of a communication system of a second embodiment.

FIG. 7 is a diagram illustrating an example of a DNS record stored in a coredns of a GC cluster.

FIG. 8 is a flowchart illustrating how the GC cluster 12 acts.

### DESCRIPTION OF EMBODIMENTS

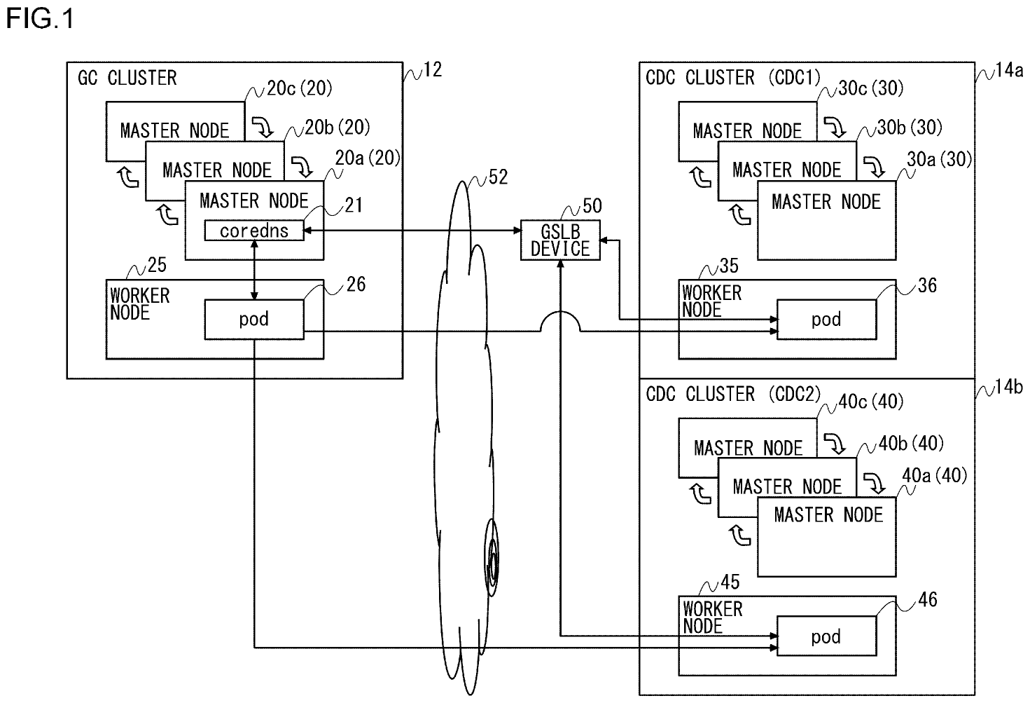

A brief description of an embodiment will be given below. FIG. 1 illustrates a configuration of a computer system in which a cluster of nodes (can also said to be computers or servers) on which a containerized application runs is constructed. FIG. 1 illustrates, as a plurality of computer systems each having the cluster constructed therein, a GC cluster 12, a CDC cluster 14a, and a CDC cluster 14b.

The GC cluster 12 is a cluster constructed in a group unit center (GC) station of a mobile network operator. The cluster of the embodiment is a set of nodes on which software (specifically, Kubernetes) for managing a containerized workload or service is installed. Further, the cluster of the embodiment is a Kubernetes cluster corresponding to a range where Kubernetes is allowed to manage a pod corresponding to the containerized application. The Kubernetes cluster can also be said to be a set of a plurality of nodes to which Kubernetes can deploy the pod.

The GC cluster 12 includes a plurality of master nodes 20 (a master node 20a, a master node 20b, and a master node 20c) and a plurality of worker nodes 25 (FIG. 1 illustrates one of the worker nodes 25). Each worker node 25 has a pod 26 deployed thereto, the pod 26 corresponding to an application, that is, the containerized application, responsible for performing various types of data processing (such as business processing). The pod 26 can also be said to be a cloud-native network function (CNF) instance.

Each of the plurality of master nodes 20 is a node responsible for managing a plurality of worker nodes 25 and a plurality of pods 26. The plurality of master nodes 20 each includes a coredns 21 that is a DNS server providing a name resolution service for the pods 26 in the cluster. Note that one leader is elected from among the plurality of master nodes 20, and FIG. 1 illustrates a case where the master node 20a is elected as the leader.

The CDC cluster 14a is a Kubernetes cluster constructed in a CDC1 that is a first central data center (CDC) of the mobile network operator. The CDC cluster 14a includes a plurality of master nodes 30 (a master node 30a, a master node 30b, and a master node 30c) and a plurality of worker nodes 35 (FIG. 1 illustrates one of the worker nodes 35). Each worker node 35 has a pod 36 deployed thereto, the pod 36 being responsible for performing various types of data processing (such as business processing).

The CDC cluster 14b is a Kubernetes cluster constructed in a CDC2 that is a second CDC of the mobile network operator. The CDC cluster 14b includes a plurality of master nodes 40 (a master node 40a, a master node 40b, and a master node 40c) and a plurality of worker nodes 45 (FIG. 1 illustrates one of the worker nodes 45). Each worker node 45 has a pod 46 deployed thereto, the pod 46 being responsible for performing various types of data processing (such as business processing).

According to the embodiment, the pod 26 of the GC cluster 12 transmits data (hereinafter, also referred to as “target data”) on application processing to the pod 36 of the CDC cluster 14a. The target data contains, for example, a processing result of the pod 26 deployed in the GC cluster 12. When a failure occurs in the CDC cluster 14a, the pod 26 of the GC cluster 12 transmits the target data to the pod 46 of the CDC cluster 14b instead of the pod 36 of the CDC cluster 14a.

Hitherto, in order to perform communications between nodes of different Kubernetes clusters, it is necessary to access a GSLB device 50 (also referred to as an infrastructure DNS) provided outside the clusters to resolve a name of a transmission destination pod (for example, the pod 36). The GSLB device 50 periodically transmits predetermined data to the pod 36 of the CDC cluster 14a for a periodic health check on the pod 36. Further, the GSLB device 50 periodically transmits the predetermined data to the pod 46 of the CDC cluster 14b for a periodic health check on the pod 46.

The pod 26 of the GC cluster 12 requests the coredns 21 to resolve a name of a transmission destination pod (for example, a transmission destination virtual domain name obtained by virtualizing the pod 36 and the pod 46). The coredns 21 requests the GSLB device 50 to resolve the name of the transmission destination pod. When the pod 36 of the CDC cluster 14a is under a normal condition, the GSLB device 50 transmits an IP address of the pod 36 to the coredns 21 of the GC cluster 12 as a response to the name resolution request. The coredns 21 returns the IP address of the pod 36 to the pod 26 in the cluster to which the coredns 21 belongs. The pod 26 transmits the target data to the pod 36 of the CDC cluster 14a using the IP address of the pod 36 given from the coredns 21.

On the other hand, when the pod 36 of the CDC cluster 14a is under an abnormal condition, the GSLB device 50 detects the abnormality. The GSLB device 50 transmits an IP address of the pod 46 of the CDC cluster 14b to the coredns 21 of the GC cluster 12 as a response to the name resolution request. The coredns 21 returns the IP address of the pod 46 to the pod 26 in the cluster to which the coredns 21 belongs. The pod 26 transmits the target data to the pod 46 of the CDC cluster 14b using the IP address of the pod 46 given from the coredns 21.

The GC cluster 12 and the GSLB device 50 are connected over a WAN 52 including a layer 2 (L2) communication section (for example, Ethernet (registered trademark)). Here, when a failure occurs in the L2 communication path on the WAN 52 under a normal condition, it takes a relatively long time to switch to a backup L2 communication path. Therefore, when a failure occurs in the WAN 52 between the GC cluster 12 and the GSLB device 50, it takes time to retrieve the IP address of the transmission destination Pod from the GSLB device 50, which may cause a delay in communications between the GC cluster 12 and the CDC cluster 14a (or the CDC cluster 14b).

According to first and second embodiment of the present disclosure, for communications between a plurality of Kubernetes clusters, a packet that is repeatedly transmitted from a transmission destination Kubernetes cluster every several seconds for monitoring whether a path between a transmission source Kubernetes cluster and the transmission destination Kubernetes cluster is under a normal condition is used for reducing a delay in the communications between the plurality of Kubernetes clusters. The packet according to the embodiment is a bidirectional forwarding detection (BFD) packet that is transmitted and received by a BFD function.

### First Embodiment

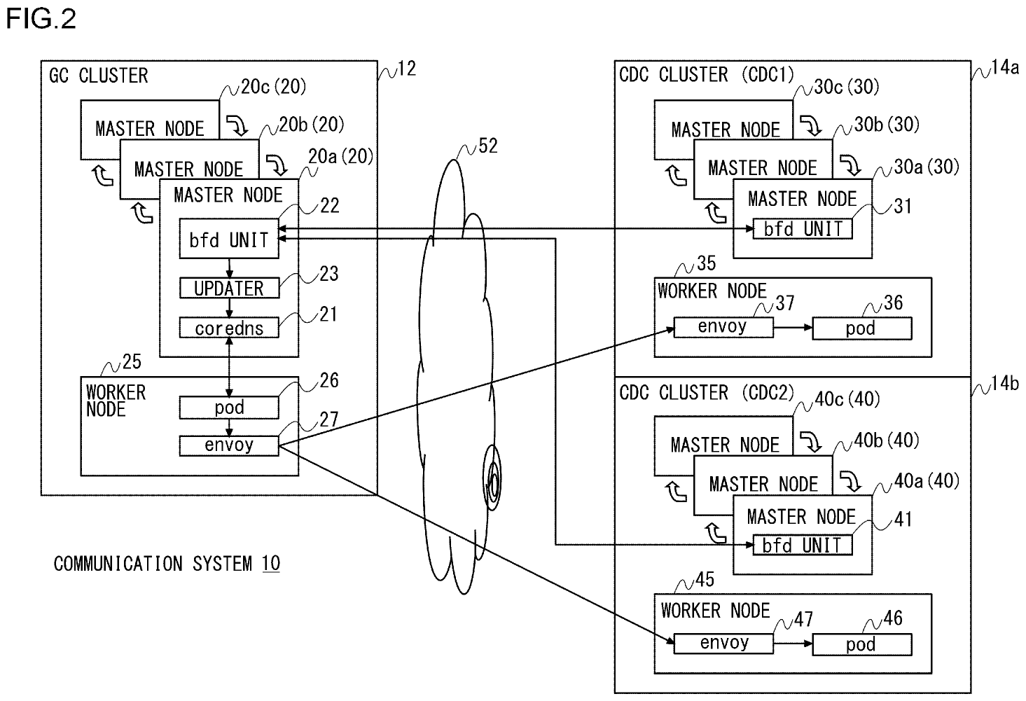

FIG. 2 illustrates a configuration of a communication system 10 of the first embodiment. FIG. 2 includes a block diagram illustrating functional blocks included in each component of the communication system 10. In terms of hardware, each block shown in the block diagram of the present disclosure can be implemented by an element such as a CPU and memory of a computer or a mechanical device, and in terms of software, the block can be implemented by a computer program or the like. However, functional blocks each implemented via cooperation between such hardware and software are depicted herein. It is to be understood by those skilled in the art that these functional blocks can be implemented in various forms by a combination of hardware and software.

The GC cluster 12 of the communication system 10 is the same in node configuration as the above-described GC cluster 12 illustrated in FIG. 1. The GC cluster 12 of the communication system 10 is a computer system having a Kubernetes cluster constructed therein, the Kubernetes cluster corresponding to a cluster of nodes on which a Pod runs. Further, the GC cluster 12 is a computer system serving as a transmission source of transmission target data (hereinafter referred to as “target data”) on processing of the Pod. The GC cluster 12 includes, in nodes (that is, nodes constituting the cluster), a communication unit that communicates with a plurality of external systems (the CDC cluster 14a and the CDC cluster 14b according to the first embodiment). The communication unit includes a bfd unit 22 provided in the master node 20 and an envoy 27 provided in the worker node 25. Details of the bfd unit 22 and the envoy 27 will be described later.

The master node 20 includes the coredns 21, the bfd unit 22, and an updater 23. The worker node 25 includes the pod 26 and the envoy 27. It can be said that the envoy 27 is a proxy unit defined by a known service mesh, the proxy unit being structured to act as a proxy to hook transmission data output from a transmission source application and transmit the transmission data to a transmission destination application in accordance with a predetermined communication protocol.

The GC cluster 12 is connected to the CDC cluster 14a and the CDC cluster 14b over the WAN 52 including the L2 communication section. The CDC cluster 14a of the communication system 10 is the same in node configuration as the above-described CDC cluster 14a illustrated in FIG. 1.

The CDC cluster 14a is a computer system having a Kubernetes cluster constructed therein and is a first external computer system serving as an original transmission destination of the target data. The master node 30 includes a bfd unit 31. The worker node 35 includes the pod 36 and an envoy 37.

The CDC cluster 14b of the communication system 10 is the same in node configuration as the above-described CDC cluster 14b illustrated in FIG. 1. As with the CDC cluster 14a, the CDC cluster 14b is a computer system having a Kubernetes cluster constructed therein. The CDC cluster 14b is a second external computer system serving as a transmission destination of the target data on behalf of the CDC cluster 14a when a failure occurs in the CDC cluster 14a or when a failure occurs in a communication path between the GC cluster 12 and the CDC cluster 14a. The master node 40 includes a bfd unit 41. The worker node 45 includes the pod 46 and an envoy 47.

The function of at least one functional block on a node may be implemented by a computer-readable computer program. This computer program may be stored in a non-transitory recording medium or may be installed in a storage of the node via the recording medium. Alternatively, the computer program may be downloaded over a network and installed in the storage of the node. A CPU of the node may load the computer program into a main memory and then execute the computer program to activate the function of at least one functional block included in the node.

The bfd unit 22 of the GC cluster 12 sequentially receives, as a receiver of the communication unit, a BFD packet repeatedly transmitted from the bfd unit 31 of the CDC cluster 14a every several seconds. When the BFD packet has not been received from the CDC cluster 14a, the pod 26 and the envoy 27 of the GC cluster 12 transmit, as a transmitter of the communication unit, the target data to the CDC cluster 14b instead of the CDC cluster 14a.

When a failure occurs in the CDC cluster 14a or when a failure occurs in the communication path between the GC cluster 12 and the CDC cluster 14a, the BFD packet is not received from the CDC cluster 14a. In this case, the GC cluster 12 can quickly detect the failure and quickly switch the transmission destination of the target data to the CDC cluster 14b.

The bfd unit 22 of the GC cluster 12 further sequentially receives, as a receiver of the communication unit, the BFD packet repeatedly transmitted from the bfd unit 41 of the CDC cluster 14b every several seconds. When the BFD packet has not been received from the CDC cluster 14a, but the BFD packet has been continuously received from the CDC cluster 14b, the pod 26 and the envoy 27 of the GC cluster 12 transmit, as a transmitter of the communication unit, the target data to the CDC cluster 14b instead of the CDC cluster 14a.

According to this aspect, when a failure occurs in the CDC cluster 14a or when a failure occurs in the communication path between the GC cluster 12 and the CDC cluster 14a, the transmission destination of the target data is quickly switched to the CDC cluster 14b on condition that communications with the CDC cluster 14b are under a normal condition. This allows the target data to be delivered to the transmission destination with higher reliability.

The coredns 21 of the GC cluster 12 resolves the name of the transmission destination of the target data for the pod 26 in the cluster. The pod 26 and the envoy 27 query, as a transmitter of the communication unit, the coredns 21 to find a transmission destination address of the target data and transmits the target data to the transmission destination address given from the coredns 21. When the BFD packet has not been received from the CDC cluster 14a, the updater 23 updates a record in the coredns 21 so as to change the transmission destination address of the target data from the address of the CDC cluster 14a to the address of the CDC cluster 14b. According to this aspect, updating the record in the coredns 21 allows the transmission destination of the target data to be flexibly changed.

A description will be given below of how the communication system 10 of the first embodiment acts.

First, an action at the time of constructing the communication system 10 will be described with reference to FIG. 2. The GC cluster 12 may include a data store (not illustrated). In the data store, the resources of the Kubernetes cluster (such as the master node 20, the coredns 21, the bfd unit 22, the updater 23, the worker node 25, the pod 26, and the envoy 27) are registered in accordance with an operation by a developer. Similarly, for the CDC cluster 14a and the CDC cluster 14b, the resources of their respective Kubernetes clusters are registered.

The bfd unit 22 of the GC cluster 12 performs negotiation with the bfd unit 31 of the CDC cluster 14a in accordance with an operation by the developer. Further, the bfd unit 22 of the GC cluster 12 performs negotiation with the bfd unit 41 of the CDC cluster 14b in accordance with an operation by the developer. Through this negotiation, a transmission destination and a transmission timing of the BFD packet are set. The GC cluster 12, the CDC cluster 14a, and the CDC cluster 14b each perform a process of electing a leader from among the master nodes 20. According to the embodiment, it is assumed that the master node 20a, the master node 30a, and the master node 40a are elected as leaders.

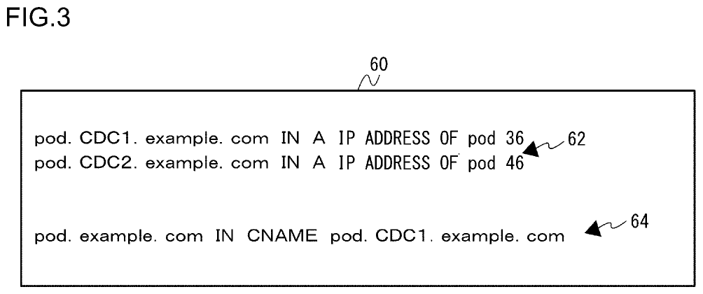

FIG. 3 illustrates an example of a DNS record stored in the coredns 21 of the GC cluster 12. FIG. 3 illustrates a DNS record initially set in the coredns 21. A DNS record 60 includes an A record 62 in which an FQDN (pod.CDC1.example.com) of the pod 36 of the CDC cluster 14a is associated with the IP address of the pod 36. The DNS record 60 further includes an A record 62 in which an FQDN (pod.CDC2.example.com) of the pod 46 of the CDC cluster 14b is associated with the IP address of the pod 46.

The DNS record 60 further includes a CNAME record 64 in which a transmission destination virtual domain name (pod.example.com) corresponding to a group of the pod 36 and the pod 46 is associated with the FQDN (pod.CDC1.example.com) of the pod 36 serving as an alias of the transmission destination virtual domain name.

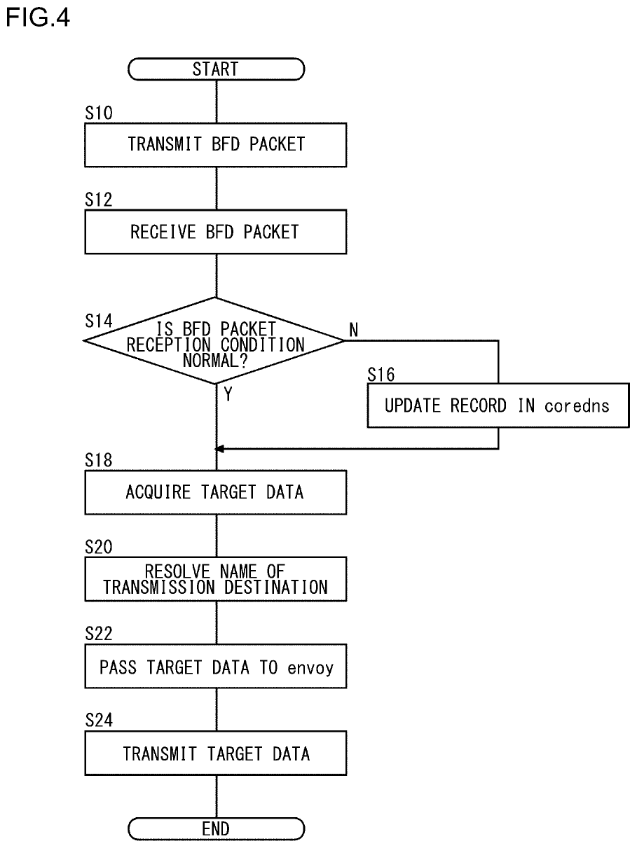

FIG. 4 is a flowchart illustrating how the GC cluster 12 acts. First, a description will be given of an action in a case where the CDC cluster 14a is under a normal condition, and the communication path between the GC cluster 12 and the CDC cluster 14a is also under a normal condition. The bfd unit 22 of the GC cluster 12 repeatedly performs a process of transmitting the BFD packet to the bfd unit 31 of the CDC cluster 14a at predetermined time intervals. Further, the bfd unit 22 repeatedly performs a process of transmitting the BFD packet to the bfd unit 41 of the CDC cluster 14b at the predetermined time intervals (S10).

Further, the bfd unit 22 of the GC cluster 12 sequentially receives the BFD packet repeatedly transmitted from the bfd unit 31 of the CDC cluster 14a at the predetermined time intervals. Further, the bfd unit 22 sequentially receives the BFD packet repeatedly transmitted from the bfd unit 41 of the CDC cluster 14b at the predetermined time intervals (S12). Here, it is assumed that both the BFD packet from the CDC cluster 14a and the BFD packet from the CDC cluster 14b are repeatedly received, for example, every several seconds. The updater 23 of the GC cluster 12 determines that the bfd unit 22 is under a normal condition for receiving the BFD packet and skips a process of updating the DNS record 60 in the coredns 21 (Y in S14).

The pod 26 of the GC cluster 12 acquires the target data to be transmitted to the CDC cluster 14a or the CDC cluster 14b (S18). The pod 26 transmits a name resolution query specifying the transmission destination virtual domain name (pod.example.com) to the coredns 21. The coredns 21 returns the IP address of the pod 36 corresponding to the transmission destination virtual domain name to the pod 26 (S20). Note that the pod 26 may sequentially search the CNAME record 64 and the A record 62 in the coredns 21 to retrieve the IP address of the pod 36 corresponding to the transmission destination virtual domain name from the coredns 21.

The pod 26 of the GC cluster 12 passes, to the envoy 27, a message containing the target data and specifying the IP address of the pod 36 as the transmission destination address (S22). The envoy 27 acts as a proxy unit to receive the target data from the pod 26 and transmit the target data to the CDC cluster 14a or the CDC cluster 14b. Here, the envoy 27 outputs the message containing the target data and specifying the IP address of the pod 36 as the transmission destination address to the WAN 52, so that the target data is transmitted to the pod 36 (envoy 37) of the CDC cluster 14a (S24).

Next, a description will be given of an action in a case where a failure occurs in the CDC cluster 14a, or a failure occurs in the communication path between the GC cluster 12 and the CDC cluster 14a. The bfd unit 22 of the GC cluster 12 has not received the BFD packet transmitted from the bfd unit 31 of the CDC cluster 14a for more than a predetermined time. On the other hand, the bfd unit 22 has continuously and repeatedly received the BFD packet transmitted from the bfd unit 41 of the CDC cluster 14b at the predetermined time intervals.

The updater 23 of the GC cluster 12 checks the BFD packet reception condition of the bfd unit 22. When the BFD packet has not been received from the CDC cluster 14a for more than the predetermined time and the BFD packet has been continuously and periodically received from the CDC cluster 14b (N in S14), the updater 23 updates a record in the coredns 21 so as to change the transmission destination address of the target data from the IP address of the pod 36 of the CDC cluster 14a to the IP address of the pod 46 of the CDC cluster 14b (S16).

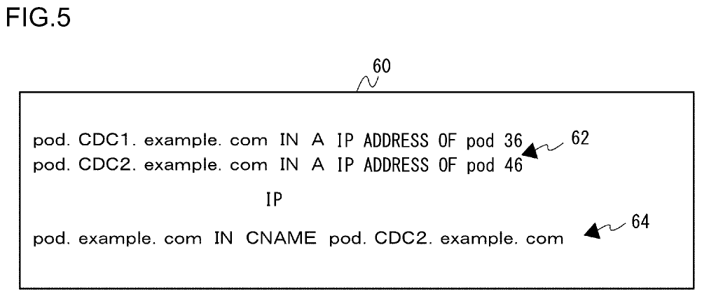

FIG. 5 illustrates an example of a DNS record stored in the coredns 21 of the GC cluster 12. FIG. 5 illustrates a DNS record after the update. The updater 23 changes the CNAME record 64 so as to associate the transmission destination virtual domain name (pod.example.com) corresponding to the group of the pod 36 and the pod 46 with the FQDN (pod.CDC2.example.com) of the pod 46 serving as an alias of the transmission destination virtual domain name.

Referring back to FIG. 4, the pod 26 of the GC cluster 12 acquires the target data (S18), and transmits the name resolution query specifying the transmission destination virtual domain name (pod.example.com) to the coredns 21 to retrieve the IP address of the pod 46 associated with the transmission destination virtual domain name from the coredns 21 (S20). The pod 26 passes a message containing the target data and specifying the IP address of the pod 46 as the transmission destination address to the envoy 27 (S22). The envoy 27 outputs the message to the WAN 52, so that the target data is transmitted to the pod 46 (envoy 47) of the CDC cluster 14b (S24). Note that the processing from S10 to S16 and the processing from S18 to S24 in FIG. 4 may be performed in parallel.

As described above, when a failure occurs in the CDC cluster 14a that is the original transmission destination of the target data, or a failure occurs in the communication path between the GC cluster 12 and the CDC cluster 14a, the GC cluster 12 of the first embodiment can quickly detect the failure on the basis of the BFD packet reception condition. The GC cluster 12 transmits, upon detection of the occurrence of such a failure, the target data to the CDC cluster 14b instead of the CDC cluster 14a, so that it is possible to reduce a delay in communications between the Kubernetes clusters.

### Second Embodiment

The present embodiment will be described below focusing on differences from the first embodiment, and no description will be given of common points as necessary. In the description, among the components of the present embodiment, components that are the same as or correspond to the components of the first embodiment will be denoted by the same reference numerals as of the components of the first embodiment.

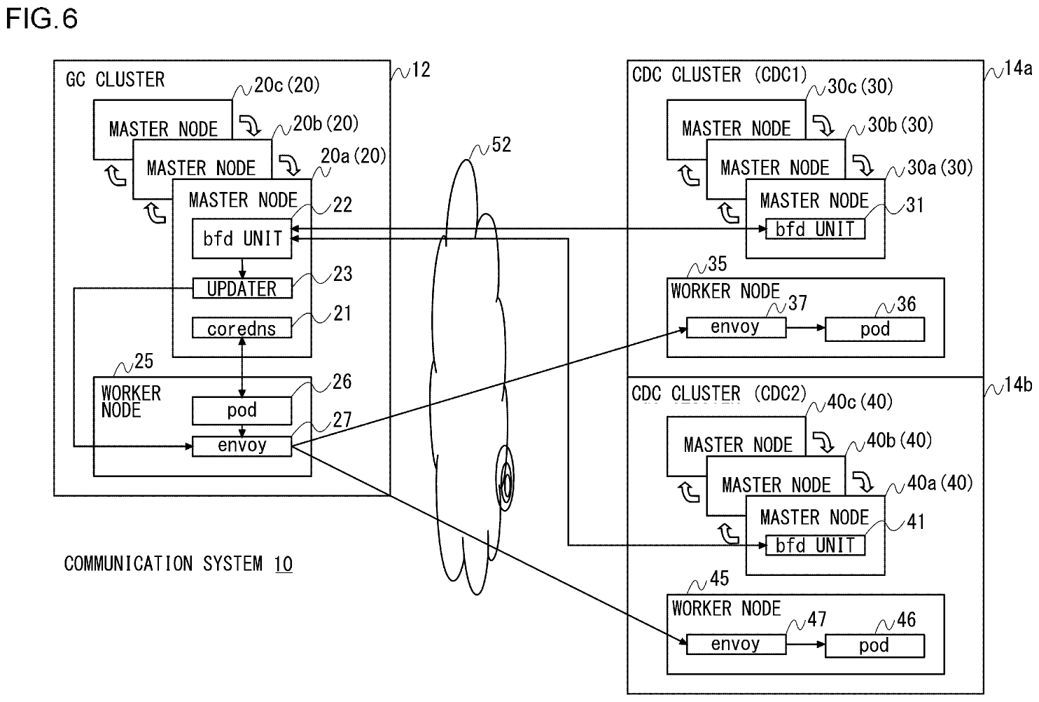

FIG. 6 is a diagram illustrating a configuration of a communication system of the second embodiment. As with the communication system 10 of the first embodiment, a communication system 10 of the second embodiment includes the GC cluster 12, the CDC cluster 14a, and the CDC cluster 14b. The node configuration and functional blocks of each cluster of the second embodiment are the same as of the first embodiment.

The envoy 27 of the GC cluster 12 acts as a proxy unit to receive the target data from the pod 26 and transmit the target data to the CDC cluster 14a. When the BFD packet has not been received from the CDC cluster 14a, the envoy 27 rewrites the transmission destination address of the target data from the IP address of the CDC cluster 14a to the IP address of the CDC cluster 14b.

A description will be given below of how the communication system 10 of the second embodiment acts. Here, how the communication system 10 acts differently from the communication system 10 of the first embodiment when a failure occurs in the CDC cluster 14a, or a failure occurs in the communication path between the GC cluster 12 and the CDC cluster 14a will be described.

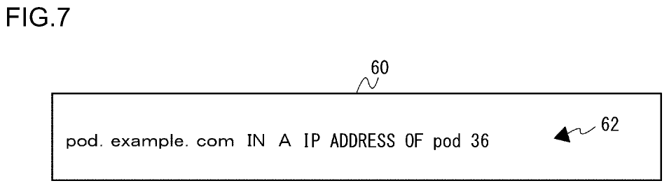

FIG. 7 illustrates an example of a DNS record stored in the coredns 21 of the GC cluster 12. The DNS record 60 includes an A record 62 in which a transmission destination virtual domain name (pod.example.com) corresponding to a group of the pod 36 of the CDC cluster 14a and the pod 46 of the CDC cluster 14b is associated with the IP address of the pod 36 of the CDC cluster 14a. The DNS record 60 of the second embodiment is different from the DNS record 60 of the first embodiment and is not changed even when the BFD packet reception condition changes.

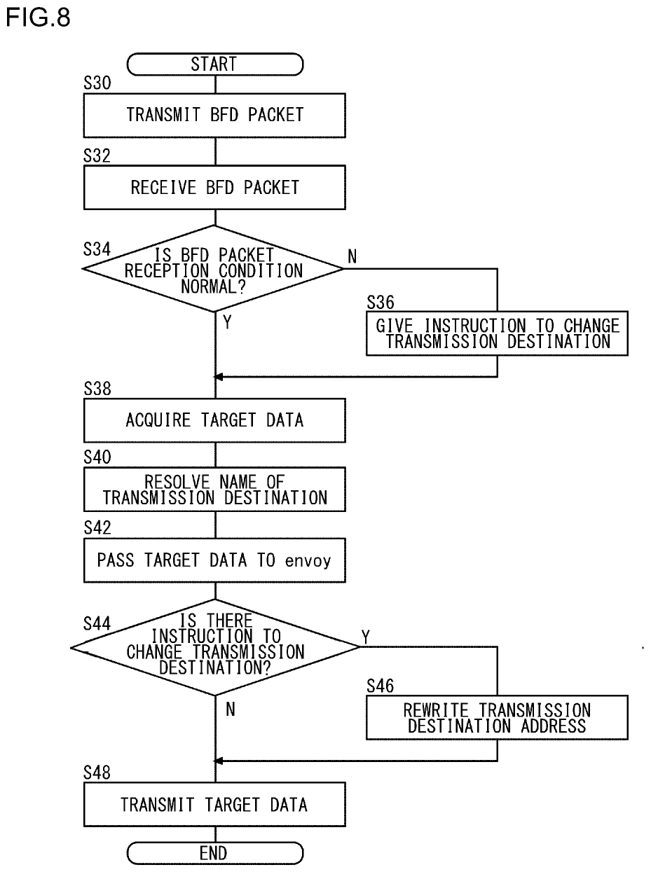

FIG. 8 is a flowchart illustrating how the GC cluster 12 acts. S30 and S32 in FIG. 8 are the same as S10 and S12 in FIG. 4, so that no description will be given of S30 and S32. The updater 23 of the GC cluster 12 checks the BFD packet reception condition of the bfd unit 22. Here, the BFD packet has not been received from the CDC cluster 14a for more than the predetermined time, but the BFD packet has been continuously and periodically received from the CDC cluster 14b.

The updater 23 determines that the BFD packet reception condition is abnormal (N in S34), and instructs the envoy 27 to change the transmission destination address of the target data from the IP address of the pod 36 of the CDC cluster 14a to the IP address of the pod 46 of the CDC cluster 14b (S36). For example, the updater 23 may store a file or a flag showing the instruction to change the transmission destination address of the target data from the IP address of the pod 36 to the IP address of the pod 46 in a storage area the envoy 27 can access. When the BFD packet reception condition is normal (Y in S34), the processing of S36 is skipped.

The pod 26 of the GC cluster 12 acquires the target data (S38), and transmits a name resolution query specifying the transmission destination virtual domain name (pod.example.com) to the coredns 21 to retrieve the IP address of the pod 36 of the CDC cluster 14a associated with the transmission destination virtual domain name from the coredns 21 (S40). The pod 26 passes a message (here, referred to as a “transmission message”) containing the target data and specifying the IP address of the pod 36 as the transmission destination address to the envoy 27 (S42).

The envoy 27 rewrites, upon receipt of the instruction to change the transmission destination address from the updater 23, that is, for example, when a file showing the instruction is stored into a predetermined storage area (Y in S44), the transmission destination address of the transmission message output from the pod 26 to the IP address of the pod 46 of the CDC cluster 14b (S46). The envoy 27 outputs the transmission message after rewriting the transmission destination address to the WAN 52, so that the target data is transmitted to the pod 46 (envoy 47) of the CDC cluster 14b (S48).

When the instruction to change the transmission destination address has not been received (N in S44), the processing of S46 is skipped. In this case, the envoy 27 outputs the transmission message output from the pod 26 to the WAN 52 without rewriting the transmission destination address, so that the target data is transmitted to the pod 36 (envoy 37) of the CDC cluster 14a (S48). Note that the processing from S30 to S36 and the processing from S38 to S48 in FIG. 8 may be performed in parallel.

The GC cluster 12 of the second embodiment produces the same effect as the GC cluster 12 of the first embodiment. That is, the communication system 10 of the second embodiment can also reduce a delay in communications between the Kubernetes clusters.

The present disclosure has been described above on the basis of the first and second embodiments. It is to be understood by those skilled in the art that these embodiments are illustrative and that various modifications are possible for a combination of components or processes, and that such modifications are also within the scope of the present disclosure.

Any combination of the above embodiments and modifications is also effective as an embodiment of the present disclosure. A new embodiment resulting from such a combination exhibits the effect of each of the embodiments and modifications constituting the combination. Further, it is to be understood by those skilled in the art that a function to be fulfilled by each of the components described in the claims can be implemented by one of the components described in the embodiments and modifications or via cooperation among the components.

### INDUSTRIAL APPLICABILITY

The technology of the present disclosure is applicable to a device or system in which a cluster of nodes on which a containerized application runs is constructed.

### REFERENCE SIGNS LIST

10 communication system, 12 GC cluster, 14a CDC cluster, 14b CDC cluster, 21 coredns, 22 bfd unit, 23 updater, 26 pod, 27 envoy, 52 WAN

1. A computer system in which a cluster of nodes on which a containerized application runs is constructed, the computer system comprising, in the nodes:
one or more processors comprising hardware, wherein
the one or more processors are configured to implement a communication unit structured to communicate with a plurality of external systems, wherein
the communication unit communicates with a first external system that is another computer system in which the cluster is constructed and to which data on the containerized application is transmitted, and a second external system that is still another computer system in which the cluster is constructed and to which the data is transmitted instead of the first external system, and
the communication unit includes a receiver structured to receive a packet repeatedly transmitted from the first external system, the packet being used for monitoring whether a path between the computer system and the first external system is under a normal condition, and a transmitter structured to transmit the data to the second external system instead of the first external system when the packet has not been received from the first external system.

2. The computer system according to claim 1, wherein
the receiver further receives a packet repeatedly transmitted from the second external system, the packet being used for monitoring whether a path between the computer system and the second external system is under a normal condition, and
the transmitter transmits the data to the second external system instead of the first external system when the packet has not been received from the first external system and the packet has been received from the second external system.

3. The computer system according to claim 1, wherein the one or more processors are further configured to implement:
a domain name system (DNS) structured to resolve a name of a transmission destination of the data; and
an updater, wherein
the transmitter queries the DNS to find a transmission destination address of the data and transmits the data to the transmission destination address given from the DNS, and
the updater updates the DNS to change the transmission destination address of the data from an address of the first external system to an address of the second external system when the packet has not been received from the first external system.

4. The computer system according to claim 1, wherein
the transmitter further includes the containerized application, and a proxy unit structured to act as a proxy to receive the data from the application and transmit the data to the first external system, and
the proxy unit rewrites a transmission destination address of the data from an address of the first external system to an address of the second external system when the packet has not been received from the first external system.

5. The computer system according to claim 1, wherein
the cluster corresponds to a range where software structured to manage the containerized application is allowed to manage the containerized application, the cluster including a plurality of nodes to which the containerized application is deployed.

6. The computer system according to claim 1, wherein
the packet transmitted from the first external system and the second external system is a bidirectional forwarding detection (BFD) packet.

7. A communication method performed by a computer system in which a cluster of nodes on which a containerized application runs is constructed, the computer system including, in the nodes, a communication unit structured to communicate with a plurality of external systems, the communication unit communicating with a first external system that is another computer system in which the cluster is constructed and to which data on the containerized application is transmitted, and a second external system that is still another computer system in which the cluster is constructed and to which the data is transmitted instead of the first external system, the communication method comprising:
causing the communication unit to receive a packet repeatedly transmitted from the first external system, the packet being used for monitoring whether a path between the computer system and the first external system is under a normal condition; and
causing the communication unit to transmit the data to the second external system instead of the first external system when the packet has not been received from the first external system.
